(19) United States
(12) Patent Application Publication
(10) Pub. No.: US 2014/0317869 A1
(43) Pub. Date: Oct. 30, 2014

(54) TOOL FOR APPLYING MORTAR

(71) Applicants: Peter Anthony Jones, North Wales (GB); Carl Anthony Jones, North Wales (GB)

(72) Inventors: Peter Anthony Jones, North Wales (GB); Carl Anthony Jones, North Wales (GB)

(21) Appl. No.: 14/260,365

(22) Filed: Apr. 24, 2014

(30) Foreign Application Priority Data
Apr. 25, 2013 (GB) GB1307515.5
May 20, 2013 (GB) GB1309087.3

(51) Int. Cl. E04F 21/16; B05D 1/40

(52) U.S. Cl. CPC E04F 21/161; B05D 1/40
USPC 15/235.4; 427/356

(57) ABSTRACT

A tool for spreading mortar in laying bricks or blocks and a method for using such a tool are disclosed. The tool comprises a body that has a long axis, wherein transverse to the long axis, the body has a cross-section that defines a chamber under a flat upper wall and between side walls, the chamber having a height that decreases from a leading edge to a trailing edge of the upper wall. In the method, the tool is placed such that the chamber substantially spans the layer of mortar, and moving the tool along the layer of mortar with the leading foremost while applying a force to the tool in a direction substantially normal to the upper wall, whereby the mortar layer is formed into a mortar bed.

### BACKGROUND TO THE INVENTION

1. Field of the Invention

This invention relates to a tool for applying mortar. It has particular application to a tool to assist in construction using bricks or blocks. The term “blocks” will be used in this specification to refer to all types of building construction unit, including, but not limited to bricks and blocks of concrete.

### SUMMARY OF THE PRIOR ART

During construction of a wall of blocks, a bricklayer places a bed of mortar on top of a footing or a previously laid course of blocks. A course of blocks are then placed upon the bed of mortar, and these have to be pushed or tapped down to the correct height to align the newly laid blocks and to form a consistent bed of mortar between the courses of blocks.

With this method of bricklaying, excess mortar can run down the face of the blocks or fall into a cavity between leaves of a cavity wall. The mortar between the blocks on the face side of the wall (that is, the side of the wall that is exposed and visible in the final construction) is usually pointed. The pointed mortar may be recessed, flat, angled, concave, or amongst other styles. Pointing is typically done by dragging a pointing tool along the wet mortar in-between the laid blocks.

The process of laying and levelling the bed of mortar, and pointing are time consuming and require skill to perform well.

FR-A-2 698 118 discloses a mortar spreader with lateral movement and sloping straight edge that moves on runners set at fixed height. The spreader includes a detachable motorised drive.

### SUMMARY OF THE INVENTION

An aim of this invention is to enable a flat and uniform bed of mortar to be produced more quickly and easily than using conventional techniques, and optionally to facilitate the procedure for pointing the mortar.

To this end, the present invention provides a tool for spreading mortar in laying blocks, the tool comprising a body that has a long axis, wherein transverse to the long axis, the body has a cross-section that defines a chamber under a flat upper wall and between side walls, the chamber having a height that decreases from a leading edge to a trailing edge of the upper wall.

Such a tool can be used to smooth and compress a layer of mortar onto the substrate and thereby transform the layer into a bed on which a course of blocks can be laid.

The tool may first and second handles spaced apart along a long axis of the body. One such tool may be suited to draw the tool axially, while the other may be suited to press the tool onto a mortar layer.

In some embodiments of the invention, the upper wall and the side walls are formed as a single piece. Alternatively, the upper wall and the side walls may be formed as separate interconnected components, or as parts of interconnected components. In the latter case, the distance between the side walls is preferably adjustable, whereby the tool can use used with blocks of a range of different widths. For example, the upper wall comprises two plates between which a portion of each side wall components can be releasably clamped.

Advantageously, one or both of the side walls includes a guide that, in use, slides in contact was a face of a construction that is being built. One or both of the side walls may include a flange that, in use, slides in contact with an upper surface of a construction that is being built.

Embodiments may further include a pointing formation that operates to shape a face surface of a mortar bed that is formed by the tool. The pointing formation may be constituted by a component that can be removaby attached to one of the side walls, or it may be formed integrally with one of the side walls.

From a second aspect, this invention provides a method of applying a bed of mortar onto which a course of blocks can be laid, comprising applying a layer of mortar to an existing substrate, placing a tool, preferably embodying the first aspect of the invention, such that the chamber substantially spans the layer of mortar, and moving the tool along the layer of mortar with the leading foremost while applying a force to the tool in a direction substantially normal to the upper wall, whereby the mortar layer is formed into a mortar bed.

Where the tool used in the method has two handles, one of the handles is typically used to apply force to draw the toll along the mortar layer, and the other of the handles is typically used to apply force to press the upper surface of the tool onto the mortar layer.

Where the tool used in the method has a side wall that includes a guide, the guide is typically pressed into contact with a face surface of the substrate during movement of the tool along the layer of mortar.

Where the tool used in the method has a side wall that includes a flange, the or each flange is typically pressed into contact with a surface of the substrate upon which the mortar layer has been applied.

### BRIEF DESCRIPTION OF THE DRAWINGS:

FIG. 1 illustrates a first embodiment of the invention;

FIG. 2 illustrates a second embodiment of the invention;

FIG. 3 is a rear view of the embodiment of FIG. 2;

FIG. 4 shows a components of the embodiment of FIG. 2; and

FIG. 5 shows an embodiment of the invention in use.

### DETAILED DESCRIPTION OF EMBODIMENTS OF THE INVENTION

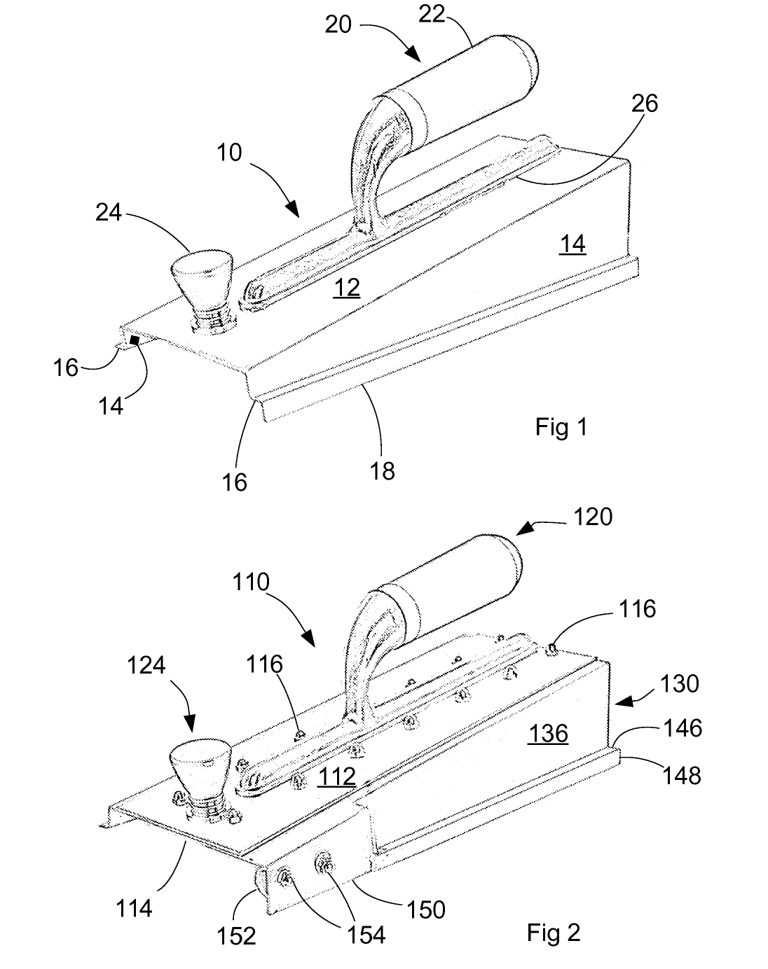

A first embodiment of the invention will now be described with reference first to FIG. 1.

The tool embodying the invention has a body 10 that is formed from a durable material, typically sheet stainless steel. The body 10 is formed with a generally planar, rectangular top panel 12 that has two long edges and two short edges. A respective spaced, parallel side wall 14 extends from each long edge at a right angle with the top panel 12. Each side 14 wall is shaped as a right-angled trapezium, with three sides at 90° to one another and a fourth side, which adjoins a long edge of the top panel 12. The fourth side extends at an angle of approximately 10°. Thus, when the fourth sides are placed on a level surface, the top panel 12 slopes with respect to that surface, whereby wedge-shaped chamber of an inverted, square U-shaped cross-section is defined below the top panel 12. The uppermost surface of the top panel 12, when in this position, will be referred to as its upper surface, and in general references to “upper”, “lower” when used in this specification assume that the tool is in this position. The higher edge of the top panel 12 will be referred to as the leading edge, and the lower edge of the top panel will be referred to as the trailing edge.

A flange 16 extends outwardly from a lower edge of each side wall 14. An extended guide 18 extends from an outer edge of one of the flanges 16 in a direction generally parallel to the side wall 14.

A pull handle 20 is attached to the top panel 12 of the tool. The pull handle can has a grasping portion 22 that extends parallel to a long centre line of the top panel 12 and that is spaced from the top panel 12. The pull handle also has an elongate attachment portion 26 that is connected to the top panel 12 and extends along the centre line and serves to stiffen the top panel. In this embodiment, the grasping portion is connected to the attachment portion 26 at one of its ends. In alternative embodiments, the grasping portion can be secured at both ends, or centrally. A small handle 24 is attached to the top panel 12 close between the trailing edge and the pull handle 20.

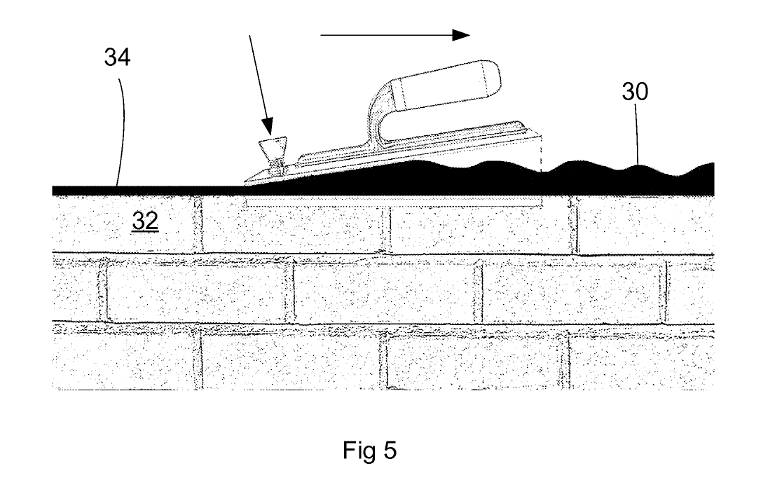

For use, a layer of mortar 30 is applied by a trowel to a course of blocks 32 that has previously been laid. The tool is then placed on the blocks, with the trailing edge of the top panel 12 close to or beyond the end of the mortar layer 30, with the extended guide 18 is to the face side of the wall being constructed. The tool is then drawn along the bed of mortar 30 using the pull handle 20, while downward pressure is applied to the small handle 24, as shown in FIG. 5. The effect of this is to compress and spread the mortar layer 30 into a bed of mortar 34 of uniform, consistent thickness upon which a further course of blocks can be laid. The presence of the extended guide 18 creates a smooth and trim outer edge of the mortar layer 34 close to the outer face of the blocks, which significantly simplifies the task of pointing the mortar, or even avoids the need for pointing altogether.

While the tool is being drawn, the extended guide 18 abuts and slides along a vertical face surface of the course of blocks. The flanges 16 slide along an upward-facing surface of the blocks.

Typically, bricks are classed as having various different nominal widths (for instance, 4 inch/102.5 mm, 6 inch/140 mm and 9 inch/215 mm), they are not always the exact size. Blocks in general can come in a wide range of sizes. Different embodiments of the invention are manufactured in different widths to accommodate this.

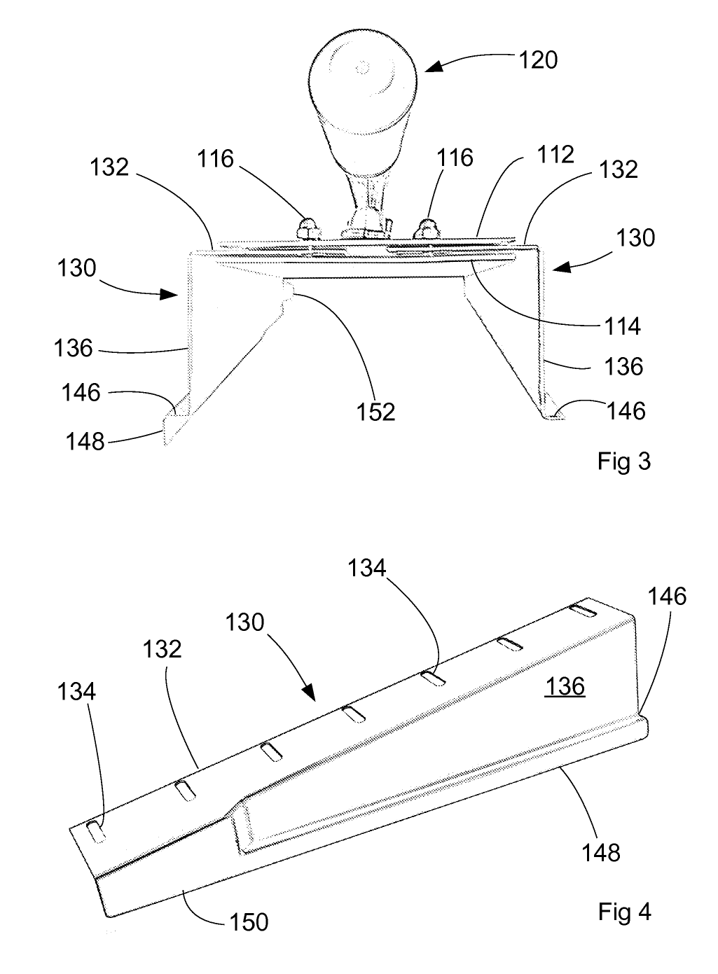

An alternative embodiment of the invention is shown in FIGS. 2 to 4. This embodiment can be used in laying blocks of a range of widths and enables a variety of pointing effects to be achieved.

In this embodiment, the body 110 is formed from four principal components: an outer top panel 112, and inner top panel 114, and two side components 130, all formed from a durable material, typically sheet stainless steel

Each of the outer top panel 112 and the inner top panel 114 are rectangular plates. Two rows of holes are formed through the outer top panel 112. Two rows of threaded studs project from the inner top panel 114 each passing through a respective hole in the outer top panel 112. The outer top panel 112 and the inner top panel 114 are retained together by a plurality of nuts 116, each being secured on a respective stud.

As with the first embodiment, this tool includes a pull handle 120 and a small handle 124 which are, in this embodiment, carried on the outer top panel 112.

Each side component 130 has a rectangular retaining flange 132 that is flat, is of length similar to the top panels 112, 114, and which has a plurality of spaced, parallel slots 134. A respective side wall 136 extends at a right angle from a long edge of the retaining flange 132. Each side wall 136 is shaped as a right-angled trapezium, with three sides at 90° to one another and a fourth side, which adjoins a long edge of the retaining flange 132. Each side wall 136 is shaped as a right-angled trapezium, with three sides at 90° to one another and a fourth side, which adjoins a long edge of the retaining flange 132. The fourth side extends at an angle of approximately 10° to the long edge of the retaining flange 132.

A short flange 146 extends outwardly from a lower edge of each side wall 136. An extended guide 148 extends from an outer edge of one of the flanges 146 in a direction generally parallel to the side wall 136.

Insofar as it has now been described, this embodiment can be used in a manner substantially similar to that described with respect to the first embodiment.

Prior to use, the tool can be configured for use by loosening the nuts 116, and moving the side components 130 towards or away from one another, to the extent permitted by the length of the slots 134, to accommodate the width of a particular wall being built. The nuts 116 are then tightened to clamp the retaining flanges 132 between the top panels 112, 114 so fixing their relative positions for use.

In addition, a section of one or both of the side components can be adapted to carry a pointing tool. A mounting region 150 of the side wall 136 adjacent to the trailing edge is displaced laterally such that it is approximately co-planar with the extended guide 148. Holes are formed through the mounting region to enable a pointing tool 152 to be bolted to it and secured with nuts 154.

To have a flush bed of mortar to the face of the bricks, no pointing tool is attached to the mounting region 150. The securing holes in the mounting region 150 are preferably blocked for example, with grommets.

Thus, embodiments of the present invention provide an angled hand tool (mortar tool) for the uniform compressing and forming of a mortar bed, with the preferred type of pointing extruded from the front of the tool. The mortar tool also prevents mortar running down the face of the blocks, and also prevents mortar falling down into the wall cavity. The mortar tool extrudes mortar to the correct thickness and width, with the preferred type of pointing ready for the next course of blocks.

Where a specific type of pointing is required, one of a variety of shaped pointing tools 152 is secured on the mounting region. The pointing tool 152 makes contact with an outer face of the mortar bed that has been smoothed and compressed by the tool to impart a chosen profile to the face surface of the mortar.

Note that the mortar tool of FIG. 1 can be modified in a similar manner to carry a removable pointing tool. Alternatively, in either embodiment, the side wall, flange and extended guide can be shaped to form an integral pointing tool region.

Mortar is laid as normal on top of the row of bricks or blocks. The mortar tool is placed over the mortar and pressed down on top of the blocks. The mortar tool is then pulled so that the mortar enters the rear of the tool and is then extruded from the front of the tool. The required type of pointing will be extruded from the mortar tool with a pointing attachment secured to the part of the tool where the mortar exits.

Mortar can be put on the ends of the blocks with a trowel traditionally or can be extruded with the mortar tool. To extrude mortar onto the ends of the blocks, firstly the blocks are placed in a row vertically (a trough can be used to secure the blocks, or the blocks can be clamped together or secured with a block at each end). The mortar is then placed on top of the bricks and the mortar tool is used as described. Finally, a trowel is inserted in-between the bricks to slice the mortar. The blocks are then ready to be placed into position upon the bed of mortar.

What is claimed is:

1. A tool for spreading mortar in laying bricks or blocks, the tool comprising:
a body having a long axis;
wherein transverse to the long axis, the body has a cross-section that defines a chamber under a flat upper wall and between side walls, the chamber having a height that decreases from a leading edge to a trailing edge of the upper wall.

2. The tool of claim 1 having first and second handles spaced apart along a long axis of the body.

3. The tool of claim 1 in which the upper wall and the side walls are formed as a single piece.

4. The tool of claim 1 in which the upper wall and the side walls are formed as separate interconnected components.

5. The tool of claim 4 in which the distance between the side walls is adjustable.

6. The tool of claim 5 in which the upper wall comprises two plates between which a portion of each side wall components can be releasably clamped.

7. The tool of claim 1 in which one or both of the side walls includes a guide that, in use, can slide in contact with a face of a construction that is being built.

8. The tool of claim 1 in which one or both of the side walls includes a flange that, in use, slides in contact with an upper surface of a construction that is being built.

9. The tool of claim 1 further including a pointing formation that operates to shape a face surface of a mortar bed that is formed by the tool.

10. The tool of claim 9 in which the pointing formation is constituted by a component that can be removaby attached to one of the side walls.

11. A method of applying a bed of mortar onto which a course of bricks or blocks can be laid, comprising:
applying a layer of mortar to an existing substrate,
placing a tool for spreading mortar on the layer of mortar, the tool comprising a body that has a long axis, wherein transverse to the long axis, the body has a cross-section that defines a chamber under a flat upper wall and between side walls, the chamber having a height that decreases from a leading edge to a trailing edge of the upper wall; the tool being placed such that the chamber substantially spans the layer of mortar, and
moving the tool along the layer of mortar with the leading foremost while applying a force to the tool in a direction substantially normal to the upper wall, whereby the mortar layer is formed into a mortar bed.

12. A method of applying a bed of mortar onto which a course of bricks or blocks can be laid, comprising:
applying a layer of mortar to an existing substrate,
placing a tool for spreading mortar on the layer of mortar, the tool comprising a body that has a long axis, wherein transverse to the long axis, the body has a cross-section that defines a chamber under a flat upper wall and between side walls, the chamber having a height that decreases from a leading edge to a trailing edge of the upper wall, and first and second handles spaced apart along a long axis of the body; the tool being placed such that the chamber substantially spans the layer of mortar, and
moving the tool along the layer of mortar with the leading foremost while applying a force to the tool in a direction substantially normal to the upper wall one of the handles being used to apply force to draw the tool along the mortar layer, and the other of the handles being used to apply force to press the upper surface of the tool onto the mortar layer, whereby the mortar layer is formed into a mortar bed.

13. A method of applying a bed of mortar onto which a course of bricks or blocks can be laid, comprising:
applying a layer of mortar to an existing substrate,
placing a tool for spreading mortar on the layer of mortar, the tool comprising a body that has a long axis, wherein transverse to the long axis, the body has a cross-section that defines a chamber under a flat upper wall and between side walls, the chamber having a height that decreases from a leading edge to a trailing edge of the upper wall in which one or both of the side walls includes a guide that, in use, slides in contact with a face of a construction that is being built; the tool being placed such that the chamber substantially spans the layer of mortar, and
moving the tool along the layer of mortar with the leading foremost while applying a force to the tool in a direction substantially normal to the upper wall, whereby the mortar layer is formed into a mortar bed, and in which the guide is pressed into contact with a face surface of the substrate during movement of the tool along the layer of mortar.

14. A method of applying a bed of mortar onto which a course of bricks or blocks can be laid, comprising:
applying a layer of mortar to an existing substrate,
placing a tool for spreading mortar on the layer of mortar, the tool comprising a body that has a long axis, wherein transverse to the long axis, the body has a cross-section that defines a chamber under a flat upper wall and between side walls, the chamber having a height that decreases from a leading edge to a trailing edge of the upper wall one or both of the side walls including a flange that, in use, slides in contact with an upper surface of a construction that is being built; the tool being placed such that the chamber substantially spans the layer of mortar, and
moving the tool along the layer of mortar with the leading foremost while applying a force to the tool in a direction substantially normal to the upper wall, the or each flange being pressed into contact with a surface of the substrate upon which the mortar layer has been applied, whereby the mortar layer is formed into a mortar bed.
